(19) United States
(12) Patent Application Publication
(10) Pub. No.: US 2016/0169761 A1
(43) Pub. Date: Jun. 16, 2016

(54) METHOD AND SYSTEM FOR ICING CONDITION DETECTION

(71) Applicant: UChicago Argonne, LLC, Chicago, IL (US)

(72) Inventors: Edwin Campos-Ortega, Naperville, IL (US); Randolph Ware, Boulder, CO (US); Paul Joe, Toronto (CA); David Hudak, Toronto (CA)

(73) Assignee: UChicago Argonne, LLC, Chicago, IL (US)

(21) Appl. No.: 14/566,416

(22) Filed: Dec. 10, 2014

(51) Int. Cl. G01L 11/00; G01N 9/00; B64D 15/20; G01K 13/02

(52) U.S. Cl. CPC G01L 11/002; G01K 13/02; G01N 9/00; B64D 15/20; G01K 2013/024

(57) ABSTRACT

System and methods for determining zones where atmospheric conditions are such that icing may occur may include receiving temperature profile data and air vapor density profile data. One or more regions indicative of conditions for supercooled droplets may be determined based on the received temperature profile data and air vapor density profile data. Data indicative of the determined one or more regions indicative of conditions for supercooled droplets may be outputted. In some implementations, the outputted data may include a visual diagram of the one or more regions, a notification, or an alert. Knowledge of such regions of conditions for supercooled droplets may assist in the avoidance or prevention of icing of components or surfaces, such as an airfoil, control surface, etc. of an aircraft, a power line, a mountainside, etc.

### STATEMENT OF GOVERNMENT INTEREST

The United States Government claims certain rights in this invention pursuant to Contract No. DE-AC02-06CH1 1357 between the United States Department of Energy and UChicago Argonne, LLC representing Argonne National Laboratory. The United States Government also claims certain rights in this invention pursuant to research sponsored by the Army Research Lab, ANL Cost Codes 167-0911500 and 167-4991300.

### FIELD

The present disclosure relates generally to systems and methods for analyzing atmospheric conditions. In particular, the disclosure relates to systems and methods for analyzing atmospheric conditions to determine zones favorable to development of supercooled droplets.

### BACKGROUND

Icing of components exposed to the elements can cause a variety of problems. For instance, icing on power lines can damage the power lines and/or disrupt power by disconnecting power lines. In other instances, icing can result in dangerous conditions on a mountain that could result in avalanches and/or other dangerous conditions.

In still further instances, icing can destroy or disrupt the smooth flow of air over airfoils, control surfaces, and/or other surfaces of an aircraft and/or other entities that are exposed to atmospheric conditions. That is, when icing conditions are present, ice accumulates on every exposed frontal surface of an aircraft, such as the wings, propeller, windshield, antennas, vents, intakes, cowlings, etc. Icing may not only affect airflow, but the added ice may increase drag while decreasing the ability of the airfoil to create lift. While the actual weight of the ice on the airplane may be insignificant for certain aircraft when compared to the airflow disruption the ice causes, adjustment for the added drag may exacerbate the icing. For instance, as power is applied to compensate for the additional drag and the nose of the aircraft is raised to maintain altitude, the angle of attack for the airfoils of the aircraft is increased, which increases the area of exposed surfaces and allows the underside of the wings and fuselage of the aircraft to further accumulate ice. If icing builds in-flight, there may be no heating devices or boots to thaw or deice the iced components of the aircraft. In some instances, the buildup of ice can change the air flow profile of the component such that an unstable condition results for the component and the increasing vibration may break the component, such as an antennae vibrating so severely that it breaks. In some further instances, an aircraft may become so iced-up that continued flight may be difficult, dangerous, and/or impossible. Moreover, the change in aerodynamics that results from the icing of the aircraft may result in stalling at higher speeds and/or lower angles of attack than under normal aerodynamic conditions. Such change in aerodynamics may result in the aircraft rolling or pitching uncontrollably.

### SUMMARY

Implementations described herein relate to identifying zones where atmospheric conditions are such that icing may occur. In particular, it may be useful to identify zones where development of supercooled droplets is likely to occur based on profiles of air temperature and water vapor. Supercooled droplets are droplets of water that exist in clouds at a temperature below the normal freezing temperature of pure water. Water droplets generally crystallize into ice below the normal freezing temperature of pure water due to the existence of ice nuclei, molecular ice-like structures in foreign surfaces or suspended particles, such as atmospheric aerosols, other compounds within the water droplet, and/or a surface the droplet contacts. If the ice nuclei have not yet been activated in a particular water droplet in the cloud, then the temperature of the water droplet may continue to decrease well below the normal freezing point while maintaining its liquid state until statistical fluctuations of the molecular arrangement of the water droplet produce a stable, ice-like structure that can serve as an ice nucleus, which crystallizes the droplet. Such supercooled droplets are likely to result in icing hazards because, once the supercooled droplets encounter ice nuclei, such as in an air mass, airfoil, control surface, etc. of an aircraft, a power line, a mountainside, etc., then the supercooled droplet quickly crystallizes into solid ice.

One implementation relates to a method for determining regions indicative of conditions for supercooled droplets. The method includes receiving temperature profile data and air vapor density profile data. The method also includes calculating vapor pressure data based on the received temperature profile data and air vapor density profile data and calculating equilibrium vapor pressure over water data based on the received temperature profile data. The method further includes determining one or more regions indicative of conditions for supercooled droplets based on the calculated vapor pressure data and the calculated equilibrium vapor pressure over water data. The method still further includes outputting data indicative of the determined one or more regions indicative of conditions for supercooled droplets.

Another implementation relates to a system that includes a radiometer, one or more processors, and one or more storage devices storing instructions that, when executed by the one or more processors, cause the one or more processors to perform several operations. The operations include receiving temperature profile data and air vapor density profile data from the radiometer. The operations also include determining one or more regions indicative of conditions for supercooled droplets based on the received temperature profile data and air vapor density profile data from the radiometer. The operations further include outputting data indicative of the determined one or more regions indicative of conditions for supercooled droplets.

A further implementation relates to a non-transitory computer readable storage device storing instructions that, when executed by one or more processors, cause the one or more processors to perform several operations. The operations include receiving temperature profile data and air vapor density profile data. The operations also include determining one or more regions indicative of conditions for supercooled droplets based on the received temperature profile data and air vapor density profile data from the radiometer. The operations further include outputting data indicative of the determined one or more regions indicative of conditions for supercooled droplets.

### BRIEF DESCRIPTION OF THE DRAWINGS

The details of one or more implementations are set forth in the accompanying drawings and the description below. Other features, aspects, and advantages of the disclosure will become apparent from the description, the drawings, and the claims, in which:

FIG. 1 is a diagram of an example environment for a system to detect atmospheric conditions favorable for supercooled droplets;

FIG. 2 is a graphical diagram of an example vertical air temperature profile and a vertical air water vapor content profile;

FIG. 3 is a graphical diagram of an example time-height plot of estimated zones of supercooled water droplet formation, evaporation deposition, and droplet-ice depletion;

FIG. 4 is a graphical diagram of another example vertical air temperature profile and a vertical air water vapor content profile;

FIG. 5 is a graphical diagram of another example time-height plot of estimated zones of supercooled water droplet formation, evaporation deposition, and droplet-ice depletion;

FIG. 6 is a flow diagram of an example process for determining regions indicative of conditions for supercooled droplets; and

FIG. 7 is a block diagram depicting a general architecture for a computer system that may be used to implement various elements of the systems and methods described and illustrated herein.

It will be recognized that some or all of the figures are schematic representations for purposes of illustration. The figures are provided for the purpose of illustrating one or more implementations with the explicit understanding that they will not be used to limit the scope or the meaning of the claims.

### DETAILED DESCRIPTION

Following below are more detailed descriptions of various concepts related to, and implementations of, methods, apparatuses, and systems for determining atmospheric regions indicative of conditions for supercooled droplets. The various concepts introduced above and discussed in greater detail below may be implemented in any of numerous ways as the described concepts are not limited to any particular manner of implementation. Examples of specific implementations and applications are provided primarily for illustrative purposes.

### I. Example Environment

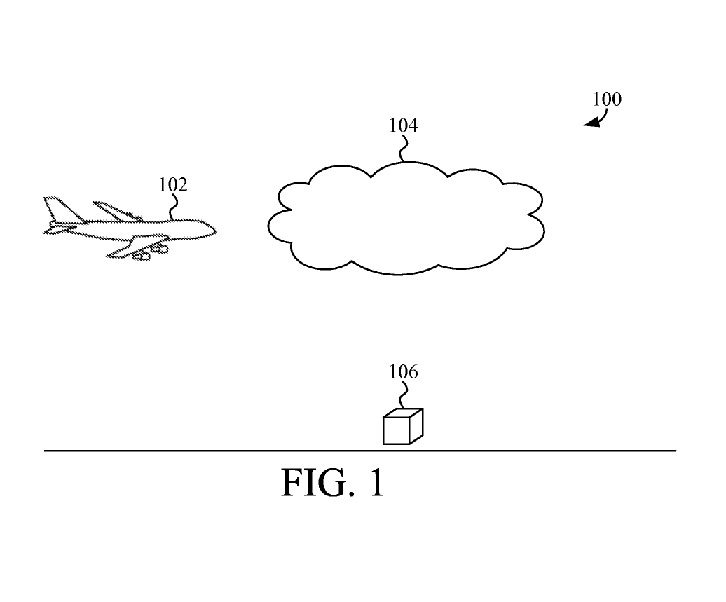

FIG. 1 depicts an example environment 100 for a system to detect atmospheric conditions favorable for supercooled droplets. For instance, aircraft 102 traveling through the environment 100 may encounter mixed-phase clouds 104. The water of such mix-phased clouds 104 may dynamically change between liquid, solid, and vapor phases based on the temperature and water vapor density of a given portion of the mix-phased cloud 104. Based on the dynamic changes that may occur, mix-phased clouds 104 may contain water vapor, ice particles, supercooled water droplets, and/or a combination of the foregoing.

Supercooled droplets are droplets of water that exist at a temperature below the normal freezing temperature of pure water. Water droplets generally crystallize into ice below the normal freezing temperature of pure water due to the existence of ice nuclei, molecular ice-like structures in foreign surfaces or suspended particles, such as atmospheric aerosols, other compounds within the water droplet, and/or a surface the droplet contacts or is in contact with. If the ice nuclei have not yet been activated in a particular supercooled droplet in the mix-phased cloud 104, then the temperature of the supercooled droplet may continue to decrease well below the normal freezing point while maintaining a liquid state until statistical fluctuations of the molecular arrangement of the supercooled droplet produce a stable, icelike structure that can serve as an ice nucleus, which crystallizes the droplet. Such supercooled droplets are likely to result in icing hazards because, once the supercooled droplets encounter ice nuclei, such as in an air mass, airfoil, control surface, etc. of the aircraft 102, a power line, a mountainside, etc., then the supercooled droplet quickly crystallizes into solid ice. Thus, detection of regions of the environment 100 having conditions favorable for the development and/or existence of such supercooled water particles may be useful.

The determination of regions of the environment 100 having conditions favorable for the development and/or existence of such supercooled water particles may be based on an air vapor pressure (e) for the region based on a temperature (T) and an air vapor density (ρ) and an equilibrium vapor pressure over liquid water (eₛ) based on the temperature T. In some implementations, a vertical temperature profile (i.e., a set of discrete temperature values at several vertical heights) and a vertical air vapor density profile (i.e., a set of discrete air vapor density values at the same or substantially the same several vertical heights) may be used to determine a vertical region profile based on the air vapor pressure (e) and the equilibrium vapor pressure over liquid water (eₛ).

In some implementations, the vertical temperature profile and/or vertical air vapor density profile may be based on predicted or forecasted data. Accordingly, the vertical region profile may be determined based on such forecasted data. In other implementations, the vertical temperature profile and/or vertical air vapor density profile may be measured data. For instance, a microwave profiling radiometer 106 may be deployed to measure and/or monitor vertical temperature and/or air vapor density to generate the vertical temperature profile and/or vertical air vapor density profile. Of course other measurement devices and/or systems for measuring vertical temperature and/or air vapor density may be utilized as well.

The forecasted and/or measured vertical temperature profile and/or vertical air vapor density profile may be forecast and/or measured over predetermined time intervals to develop a time-series of co-located vertical temperature and/or vertical air vapor density profiles. Using such time-series co-located vertical temperature and/or vertical air vapor density profiles, times-series of regions of the environment 100 having conditions favorable for the development and/or existence of such supercooled water particles may be determined

In some implementations, the regions of the environment 100 having conditions favorable for the development and/or existence of such supercooled water particles may be utilized by providing notifications to aircraft 102 in the environment. For instance, a system may output data indicative of the determined region or regions having conditions favorable for the development and/or existence of such supercooled water particles, such as the location and the vertical above ground level (AGL) bounds of the determined region or regions. In some implementations, the location and vertical AGL bounds of the determined region or regions may be output with and/or in the format of METAR, TAF, and/or other data to aircraft 102. In some implementations, the system may output data indicative of the determined region or regions only to aircraft 102 on a heading or course intersecting the location of the determined region (e.g., aircraft 102 on a vector intersecting the ground location of the region). In some instances, the output data may be data indicative of a warning or alert.

In some instances, the regions of the environment 100 having conditions favorable for the development and/or existence of such supercooled water particles may be relevant for other purposes other than aviation. For instance, regions of the environment 100 having conditions favorable for the development and/or existence of such supercooled water particles may be relevant for predicting and/or determining when icing conditions may occur on or near mountainous regions, which can result in dangerous conditions that could result in avalanches and/or other hazards. Thus, in some instances, data indicative of the determined region or regions having conditions favorable for the development and/or existence of such supercooled water particles may be output to locations on the mountainous region and/or to generate a map of regions where icing may develop. In still other instances, the regions of the environment 100 having conditions favorable for the development and/or existence of such supercooled water particles may be relevant for predicting and/or determining when icing may develop at or near ground level, which may develop ice on roads, power lines, foliage, etc. that can create dangerous conditions or cause damage. Of course other uses for the determined region or regions having conditions favorable for the development and/or existence of such supercooled water particles may be implemented as well.

### II. Determination of Regions Having Conditions Favorable for Supercooled Water Particles

The rate of condensational growth or evaporation of water droplets and/or ice particles in a mixed-phase cloud is proportional to the difference between in-cloud air vapor pressure (e) at a particular location in the mixed-phase cloud and the equilibrium vapor pressure over liquid water (eₛ) and ice (eᵢ), respectively, at that particular location in the mixed-phase cloud. At subfreezing temperatures, such as where eₛ>eᵢ, there are three possible mutually exclusive scenarios for the in-cloud air vapor pressure, e, relative to the equilibrium vapor pressure over liquid water (eₛ) and ice (eᵢ): (scenario 1) eₛ>eᵢ>e (droplet-ice depletion), (scenario 2) eₛ>e>eᵢ (evaporation deposition), or (scenario 3) e>eₛ>eᵢ (droplet-ice growth).

When the in-cloud air vapor pressure (e) is less than both the equilibrium vapor pressure over liquid water (eₛ) and ice (eᵢ), such as in scenario (1), then the water droplets and/or ice particles deplete substantially simultaneously. That is, the water droplets and/or ice particles transition into water vapor for the cloud. In some instances, droplet evaporation and ice-particle sublimation may occur as a result of entrainment and/or mixing with environmental dry air near the cloud boundaries. Thus, regions of a mixed-phase cloud where eₛ>eᵢ>e is not conducive to the growth and/or formation of supercooled water droplets.

When the in-cloud air vapor pressure (e) is less than the equilibrium vapor pressure over liquid water (eₛ), but greater than the equilibrium vapor pressure over ice (eᵢ), such as in scenario (2), then water droplets in the cloud evaporate, but ice particles may grow by vapor diffusion (i.e., deposition). Such evaporation of water droplets and growth of ice particles by vapor diffusion may result from the Wegener-Bergeron-Findeisen process, which may occur in both updrafts and downdrafts within a mixed-phase cloud. However, with the evaporation of the water droplets, regions of a mixed-phase cloud where eₛ>e>eᵢ is also not conducive to the growth and/or formation of supercooled water droplets.

When the in-cloud air vapor pressure (e) is greater than both the equilibrium vapor pressure over liquid water (eₛ) and over ice (eᵢ), such as in scenario (3), then water droplets and ice particles may both grow substantially simultaneously by vapor diffusion. The liquid droplets and ice particles may both compete for the available water vapor within the cloud. Such a condition may occur in ascending mixed-phase clouds and/or in zones of isobaric mixing. The formation and/or growth of water droplets under the conditions where e>eₛ>eᵢ may thus be conducive to the growth and/or formation of supercooled water droplets. Accordingly, when the conditions are such that e>eₛ (since eᵢ will be less than eₛ), then it may be determined that such a location is a region having conditions favorable for the development and/or existence of such supercooled water particles.

As noted above, the air vapor pressure (e) for the region is based on a temperature (T) for the region and an air vapor density (ρ) for the region. Similarly, the equilibrium vapor pressure over liquid water (eₛ) for the region is also based on the temperature T for the region. The air vapor pressure (e, in hPa) may be calculated based on Equation (1):

e=ρᵥRᵥT×10⁻⁵ (1)

where ρᵥ is the air vapor density (in g/m³), T is the temperature in Kelvins, and Rᵥ is the gas constant for water vapor of 461.5 m²s⁻²K⁻¹.

For temperature values of T of 273.15° K>T>110° K (or 0° C.>T>−163.15° C.), the equilibrium vapor pressure over ice (eᵢ, in hPa) may be calculated based on Equation (2):

$${e}_{i} = {10}^{- 2} \times exp [ {α}_{0} + \frac{{α}_{1}}{T} + {α}_{2} ln ( T ) + {α}_{3} T ] \qquad ( 2 )$$

where α₀, α₁, α₂, and α₃ are empirical coefficients having values of α₀=9.550426, α₁=−5723.265, α₂=3.53068, and α₃=−0.00728332.

For temperature values of T of 332° K>T>123° K (or 58.85° C.>T>−150.15° C.), the equilibrium vapor pressure over water (eₛ, in hPa) may be calculated based on Equation (3):

$${e}_{s} = {10}^{- 2} \times exp \{ {α}_{0} + \frac{{α}_{1}}{T} + {α}_{2} ln ( T ) + {α}_{3} T + ( tanh [ {α}_{4} ( T + {α}_{5} ) ] ) \times [ {α}_{6} + \frac{{α}_{7}}{T} + {α}_{8} ln ( T ) + {α}_{9} T ] \} \qquad ( 3 )$$

where α₀, α₁, α₂, α₃, α₄, α₅, α₆, α₇, α₈, and α₉ are empirical coefficients having values of α₀=54.842763, α₁=−6763.22, α₂=−4.210, α₃=0.000367, α₄=0.0415, α₅=−218.8, α₆=53.878, α₇=−1331.22, α₈=−9.44523, and α₉=0.014025.

Using co-located vertical temperature and vertical air vapor density profiles, values for air vapor pressure (e) for each vertical position of the co-located vertical temperature and vertical air vapor density profiles may be determined using Equation (1). Similarly, values for the equilibrium vapor pressure over water (eₛ) may be calculated using the vertical temperature profile and Equation (3). The value for air vapor pressure (e) for each vertical position may be compared to the corresponding value for the equilibrium vapor pressure over water (eₛ) for each vertical position (e.g., e−eₛ). If the value for air vapor pressure (e) is greater than the equilibrium vapor pressure over water (eₛ) for a particular vertical position (e.g., e−eₛ>0), then the vertical position may be identified as having conditions favorable for the development and/or existence of supercooled water particles

In some implementations, a statistical Student's T-test may be applied such that the e and eₛ datasets have significantly different and positive means for paired samples at a 0.01 significance level (e.g., one-tailed directional test). During implementation of the T-test for paired samples, at each particular time and height, 10+1 consecutive observations of the pair (e, eₛ) may be input. These observations are centered at the particular height and include periods at the particular time±5 time steps. If the T-test indicates that e is significantly larger than eₛ, at a significance level of 0.01 or less, then it may be concluded that the particular time and height point may have conditions favorable for supercooled droplet growth. For instance, a vertical position of a vector (or matrix) of T-test values may have a value of 0.005 if the vertical position is identified as having conditions favorable for the development and/or existence of supercooled water particles.

If a vertical position of a vector (or matrix) of T-test values has a value of 0.02, then the vertical position may be identified as not having conditions favorable for the development and/or existence of supercooled water particles. As well, if the value for air vapor pressure (e) is less than or equal to than the equilibrium vapor pressure over water (eₛ) for a particular vertical position (e.g., e−eₛ≦0), then the vertical position may be identified as not having conditions favorable for the development and/or existence of supercooled water particles.

With the various vertical positions for the vertical temperature and vertical air vapor density profiles identified as favorable or not favorable to the development and/or existence of supercooled water particles, one or more regions may be determined using the vertical positions and the identifications. For instance, the values from a vertical position vector with values of 1 or 0 corresponding to whether the vertical position is identified as having conditions favorable for the development and/or existence of supercooled water particles may be used to determine one or more regions favorable to the development and/or existence of supercooled water particles.

### III. Example Determined Regions for Supercooled Water Particles Based on Vertical Temperature and Air Vapor Density Profiles

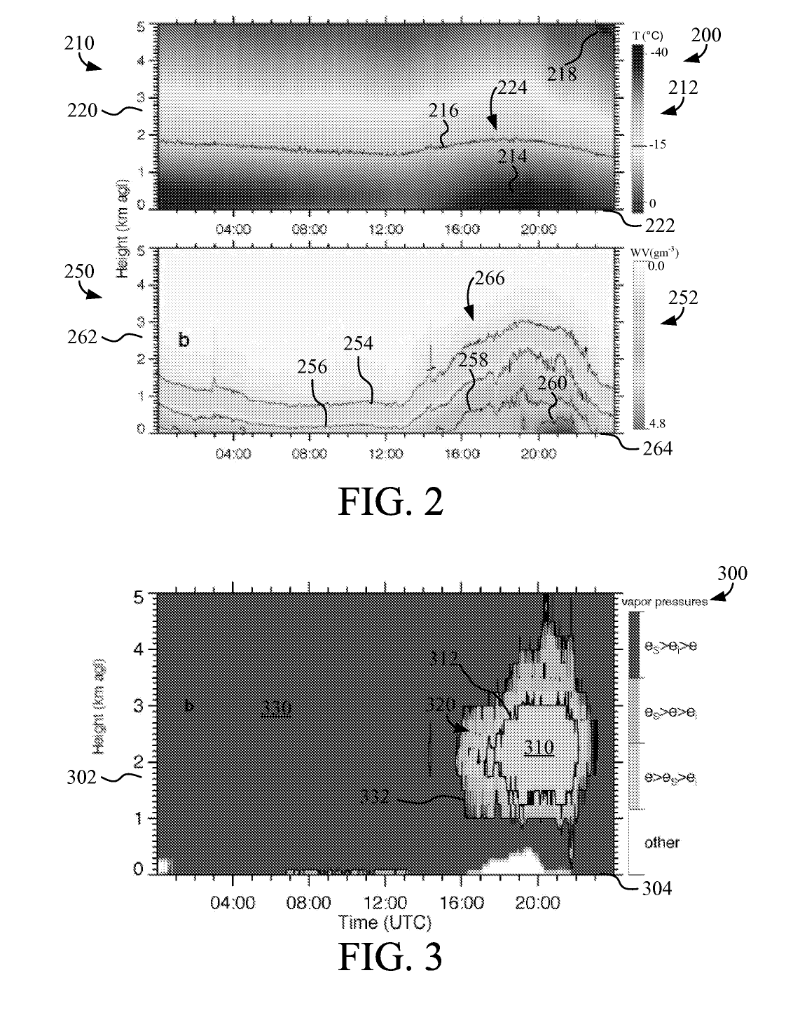

FIG. 2 depicts a graphical diagram 200 of an example vertical air temperature profile 210 and a vertical air water vapor content profile 250 for a lake-effect snow storm. In the present example, the vertical air temperature profile 210 and vertical air water vapor profile 250 are generated based on measurements from the microwave profiling radiometer 106. In other implementations, the vertical air temperature profile 210 and vertical air water vapor profile 250 may be generated based on forecasted data.

The vertical air temperature profile 210 comprises retrieved time-height cross sections of air temperature in Celsius. The scale 212 of the vertical air temperature profile 210 depicts a linear gradient of values for the vertical air temperature profile 210, including contour lines 214, 216, 218 at zero degrees Celsius 214, negative fifteen degrees Celsius 216, and negative forty degrees Celsius 218. The height axis 220 depicts the heights, in kilometers (km), at which the various temperature measurements were obtained. The time axis 222 also indicates the time at which the various temperature measurements were obtained. The vertical air temperature profile 210 thus shows the air temperature, as measured by the microwave profiling radiometer 106, at various heights and times. In the example vertical air temperature profile 210 shown, a rise 224 in temperature occurs from approximately 13:00 UTC to approximately 19:40 UTC. Thus, the temperature aloft has increased during the time period of approximately 13:00 UTC to approximately 19:40 UTC.

The vertical air water vapor profile 250 comprises retrieved time-height cross sections of air vapor density (in g/m³). The scale 252 of the vertical air water vapor profile 250 depicts a linear gradient of values for the vertical air water vapor profile 250 from approximately 0.0 g/m³ of water vapor density at higher altitudes to approximately 4.8 g/m³ at times at lower altitudes. The air water vapor profile 250 includes contour lines 254, 256, 258, 260 separating different levels of air water vapor density (e.g., 1.0 g/m³ for contour line 254, 2.0 g/m³ for contour line 256, 3.0 g/m³ for contour line 258, 4.0 g/m³ for contour line 260). The height axis 262 depicts the heights at which the various water vapor density measurements were obtained and corresponds to the height axis 220 of the vertical air temperature profile 210. The time axis 264 also indicates the time at which the various water vapor density measurements were obtained and corresponds to the time axis 222 of the vertical air temperature profile 210. The vertical air water vapor profile 250 thus shows the air water vapor density, as measured by the microwave profiling radiometer 106, at various heights and times. In the example vertical air water vapor profile 250 shown, a rise 266 in air water vapor density occurs from approximately 13:00 UTC to approximately 23:00 UTC, with a period of increase in vapor density between 13:00 UTC and 19:00 UTC and a period of decrease in vapor density between 19:00 UTC and 23:00 UTC. Thus, the air water vapor density at higher altitudes has increased during the time period of approximately 13:00 UTC to approximately 23:00 UTC.

FIG. 3 is a graphical diagram 300 of an example time-height plot of estimated zones of supercooled water droplet formation and growth 310, evaporation deposition 320, and droplet-ice depletion 330 generated based on Equations (1)-(3), the vertical air temperature profile 210, and the vertical air water vapor profile 250. The height axis 302 depicts the heights at which the estimated zones are determined and corresponds to the height axes 220, 262 of the vertical air temperature profile 210 and vertical air vapor density profile 250. The time axis 304 also indicates the time at which the estimated zones are determined and corresponds to the time axes 222, 264 of the vertical air temperature profile 210 and vertical air vapor density profile 250.

The graphical diagram 300 includes a contour 312 inside the estimated zone of supercooled water droplet formation 310, which corresponds to a 1% significance level for e−eₛ>0. In other words, this contour 312 corresponds to a 99% confidence level for the estimated zone of supercooled water droplet formation and growth 310. Similarly, a contour 322 is included for the estimated zone of droplet-ice depletion 330 for the 99% confidence level for droplet-ice depletion. A confidence level for the estimated zone of evaporation-deposition 320 is omitted for the sake of clarity. The significance levels are based on a Student's T-test for significantly different means of paired samples (e.g., e and eₛ based on the calculation of e−eₛ>0 and/or e and eᵢ based on the calculation of eᵢ−e>0). It should be appreciated that confidence levels for the contour lines can be set as various levels such that 0<confidence>100.

The estimated zone of supercooled water droplet formation and growth 310 of the graphical diagram 300 occurs from approximately 17:00 UTC to 22:00 UTC for heights above approximately 1 km and below approximately 3.5 km. Thus, the determined estimated zone of supercooled water droplet formation 310 may be utilized to provide notifications to aircraft traveling in the area and/or on a course or heading intersecting the determined estimated zone of supercooled water droplet formation 310. For instance, if the determined estimated zone of supercooled water droplet formation 310 occurs at or near an airport, a notification and/or warning may be transmitted to aircraft in the area.

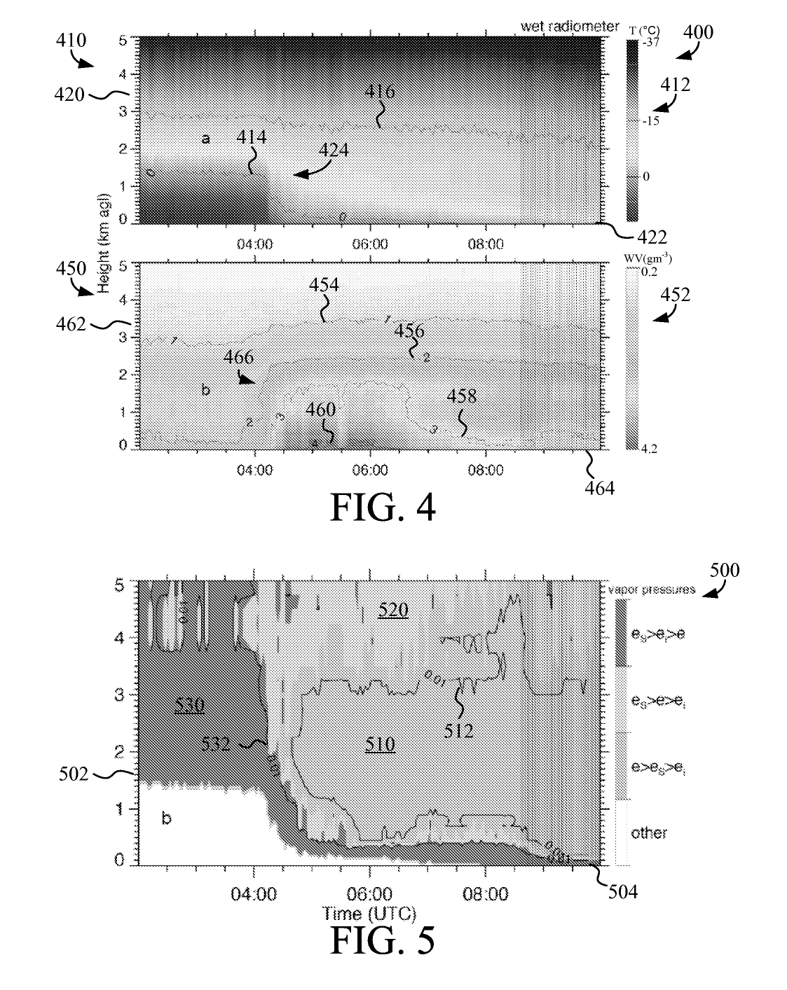

FIG. 4 is another graphical diagram 400 of another example vertical air temperature profile 410 and a vertical air water vapor content profile 450 for a winter upslope storm. In the present example, the vertical air temperature profile 410 and vertical air water vapor profile 450 are generated based on measurements from the microwave profiling radiometer 106. In other implementations, the vertical air temperature profile 410 and vertical air water vapor profile 450 may be generated based on forecasted data.

The vertical air temperature profile 410 comprises retrieved time-height cross sections of air temperature in Celsius. The scale 412 of the vertical air temperature profile 410 depicts a linear gradient of values for the vertical air temperature profile 410, including contour lines 414, 416 at zero degrees Celsius 414 and negative fifteen degrees Celsius 416. The height axis 420 depicts the heights, in kilometers (km), at which the various temperature measurements were obtained. The time axis 422 also indicates the time at which the various temperature measurements were obtained. The vertical air temperature profile 410 thus shows the air temperature, as measured by the microwave profiling radiometer 106, at various heights and times. In the example vertical air temperature profile 410 shown, a drop 424 in temperature occurs from approximately 4:15 UTC to approximately 10:00 UTC. Thus, the temperature aloft has dropped during the time period of approximately 4:15 UTC to approximately 10:00 UTC.

The vertical air water vapor profile 450 comprises retrieved time-height cross sections of air vapor density (in g/m³). The scale 452 of the vertical air water vapor profile 450 depicts a linear gradient of values for the vertical air water vapor profile 450 from approximately 0.2 g/m³ of water vapor density at higher altitudes to approximately 4.2 g/m³ at times at lower altitudes. The air water vapor profile 450 includes contour lines 454, 456, 458, 460 separating different levels of air water vapor density (e.g., 1.0 g/m³ for contour line 454, 2.0 g/m³ for contour line 456, 3.0 g/m³ for contour line 458, 4.0 g/m³ for contour line 460). The height axis 462 depicts the heights at which the various water vapor density measurements were obtained and corresponds to the height axis 420 of the vertical air temperature profile 410. The time axis 464 also indicates the time at which the various water vapor density measurements were obtained and corresponds to the time axis 422 of the vertical air temperature profile 410. The vertical air water vapor profile 450 thus shows the air water vapor density, as measured by the microwave profiling radiometer 106, at various heights and times. In the example vertical air water vapor profile 450 shown, a rise 466 in air water vapor density occurs from approximately 4:00 UTC, with a period of increase in vapor density between 4:00 UTC and 4:15 UTC and a period of decrease in vapor density after 6:00 UTC. Thus, the air water vapor density aloft has increased during the time period of approximately 4:00 UTC to approximately 10:00 UTC.

FIG. 5 is another graphical diagram 500 of an example time-height plot of estimated zones of supercooled water droplet growth 510, evaporation deposition 520, and droplet-ice depletion 530 generated based on Equations (1)-(3), the vertical air temperature profile 410, and the vertical air water vapor profile 450. The height axis 502 depicts the heights at which the estimated zones are determined and corresponds to the height axes 420, 462 of the vertical air temperature profile 410 and vertical air vapor density profile 450. The time axis 504 also indicates the time at which the estimated zones are determined and corresponds to the time axes 422, 464 of the vertical air temperature profile 410 and vertical air vapor density profile 450.

The graphical diagram 500 includes a contour 512 inside the estimated zone of supercooled water droplet growth 510, which corresponds to a 1% significance level for e−eₛ>0. In other words, this contour 512 corresponds to a 99% confidence level for the estimated zone of supercooled water droplet growth 510. Similarly, a contour 522 is included for the estimated zone of droplet-ice depletion 530 for the 99% confidence level for droplet-ice depletion. A confidence level for the estimated zone of evaporation-deposition 520 is omitted for the sake of clarity. The significance levels are based on a Student's T-test for significantly different means of paired samples (e.g., e and eₛ based on the calculation of e−eₛ>0 and/or e and eᵢ based on the calculation of eᵢ−e>0).

The estimated zone of supercooled water droplet growth 510 of the graphical diagram 500 occurs from approximately 4:40 UTC to 10:00 UTC for heights above approximately 0.5 km and below approximately 3.5 to 5 km. Thus, the determined estimated zone of supercooled water droplet formation 510 may be utilized to provide notifications to aircraft traveling in the area and/or on a course or heading intersecting the determined estimated zone of supercooled water droplet formation 510. For instance, if the determined estimated zone of supercooled water droplet formation 510 occurs at or near an airport, a notification and/or warning may be transmitted to aircraft in the area.

### IV. Example Process for Determining Regions for Supercooled Water Particles

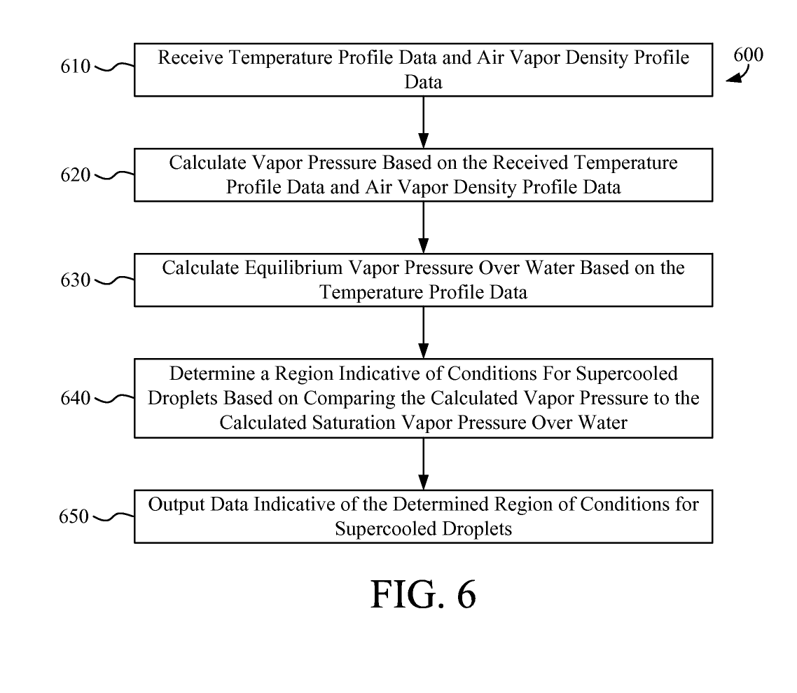

FIG. 6 a flow diagram of an example process 600 for determining regions indicative of conditions for supercooled droplets. The process 600 includes receiving temperature profile data and air vapor density profile data (block 610). The received temperature profile data and air vapor density profile data may be based on measurements from a microwave profiling radiometer 106 or the temperature profile data and air vapor profile data may be generated based on forecasted data. In some implementations, the received temperature profile data and air vapor density profile data may be discrete vectors of altitudes and temperature or air vapor density data at a single discrete time period or the received temperature profile data and air vapor density profile data may be a matrix of altitudes, times, and temperature or air vapor density data. In still further instances, the received temperature profile data and air vapor density profile data may be aggregated into a single data file.

The process 600 also includes calculating vapor pressure (e) based on the received temperature profile data and air vapor density profile data (block 620). The calculation of air vapor pressure may be done using Equation (1) and co-located (and corresponding time) values of the received temperature profile data and air vapor density profile data. In some instances, the process 600 may iterate through the vector or matrix data of the received temperature profile data and air vapor density profile data to generate a vector or matrix of air vapor pressures.

The process 600 further includes calculating equilibrium vapor pressure over liquid water (eₛ) based on the received temperature profile data (block 630). The values for the equilibrium vapor pressure over water (eₛ) may be calculated using the received temperature profile data and Equation (3) for each location (and for the same corresponding time). In some instances, the process 600 may iterate through the vector or matrix data of the received temperature profile data to generate a vector or matrix of equilibrium vapor pressures over liquid water.

The process 600 still further includes determining a region indicative of conditions for supercooled droplets based on comparing the calculated vapor pressure to the calculated equilibrium vapor pressure over water (block 640). In some implementations, determining a region indicative of conditions for supercooled droplets is based on a Student's T-test using the calculated vapor pressure to the calculated equilibrium vapor pressure over water. The value for air vapor pressure (e) for each vertical position (and, in some instances, corresponding time) may be compared to the corresponding value for the equilibrium vapor pressure over water (eₛ) for each vertical position (e.g., e−eₛ).

If the value for air vapor pressure (e) is greater than the equilibrium vapor pressure over water (eₛ) for a particular position (e.g., e−eₛ>0), then the position may be identified as having conditions favorable for the development and/or existence of supercooled water particles. For instance, a vertical position vector (or matrix) may have a value of 1 if the position is identified as having conditions favorable for the development and/or existence of supercooled water particles.

If the value for air vapor pressure (e) is less than or equal to than the equilibrium vapor pressure over water (eₛ) for a particular position (e.g., e−eₛ≦0), then the position may be identified as not having conditions favorable for the development and/or existence of supercooled water particles. The vertical position vector (or matrix) may have a value of 0 if the position is identified as not having conditions favorable for the development and/or existence of supercooled water particles.

In some implementations, additional regions may be determined, such as regions indicative of evaporation deposition and/or droplet-ice depletion based on comparing the air vapor pressure (e) to the equilibrium vapor pressure over ice (eᵢ) and/or equilibrium vapor pressure over water (eₛ) for a particular position. In some implementations, the additional regions may be determined based on Student's T-tests using the air vapor pressure (e) to the equilibrium vapor pressure over ice (eᵢ) and/or equilibrium vapor pressure over water (eₛ) for a particular position and over a time interval. If, for instance, the air vapor pressure (e) is less than the equilibrium vapor pressure over water (eₛ), but greater than the equilibrium vapor pressure over ice (eᵢ), then the particular position may be determined as corresponding to a region indicative of evaporation deposition. If the air vapor pressure (e) is less than the equilibrium vapor pressure over water (eₛ) and the equilibrium vapor pressure over ice (eᵢ), then the particular position may be determined as corresponding to a region indicative of droplet-ice depletion. In some implementations, values for separate position vectors or matrices may be generated based on the determination and/or separate values may be included in the vector or matrix with the values for the positions identified as having conditions favorable for the development and/or existence of supercooled water particles (e.g., a value of 0 for droplet-ice depletion, 1 for evaporation deposition, and 2 for conditions favorable for the development and/or existence of supercooled water particles).

The process 600 also includes outputting data indicative of the determined region of conditions favorable for the development and/or existence of supercooled water particles (block 650). For instance, the region may be determined by applying a Student's T-test that e and eₛ datasets have significantly different and positive means, for paired samples at the 0.01 significance level (e.g., one-tailed directional test). The outputting of data may be simply outputting the vector or matrix of values indicative of whether a position is identified as having or not having conditions favorable for the development and/or existence of supercooled water particles. In other implementations, the outputting of data may include generating a visual diagram of the T-test significance levels as a function of height and time or a visual diagram of the positions identified as having or not having conditions favorable for the development and/or existence of supercooled water particles, such as those shown in FIGS. 3 and 5.

In still further implementations, the outputting of data may include generating a notification or alert for aircraft in response to determining a region having conditions favorable for the development and/or existence of supercooled water particles. Such outputting of a notification or alert may include the vertical bounds of the positions having conditions favorable for the development and/or existence of supercooled water particles (e.g., an upper and lower height above ground level (AGL)). In some implementations, the notification or alert may be output with and/or in the format of METAR, TAF, and/or other data to aircraft. Of course other outputs of the data indicative of one or more regions having conditions favorable for the development and/or existence of supercooled water particles may be implemented as well.

### V. Example System

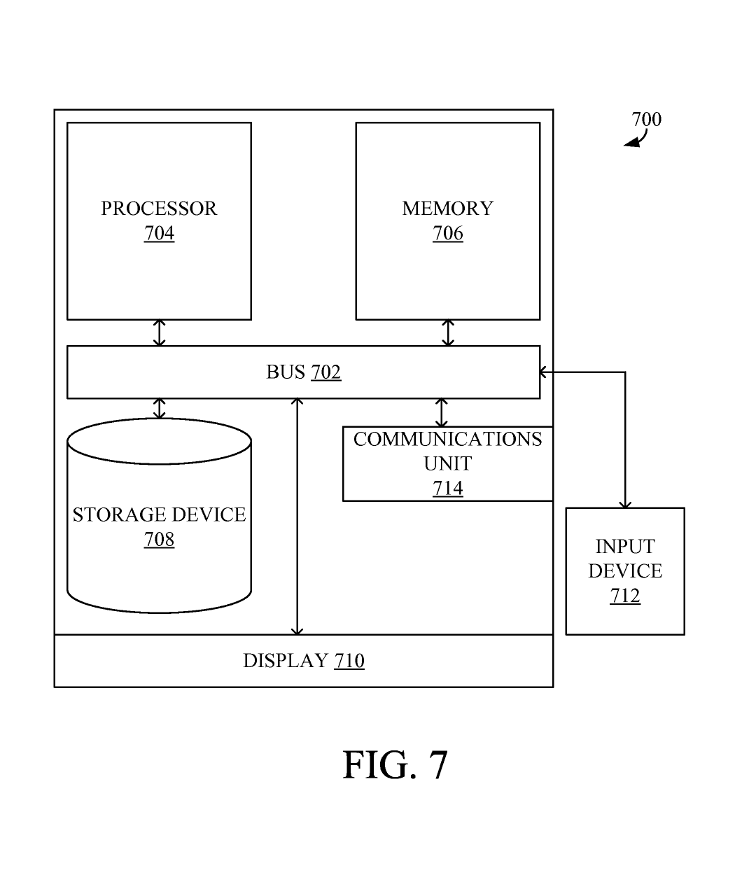

FIG. 7 is a block diagram of a computer system 700 that can be used to implement the process 600. The computing system 700 includes a bus 702 or other communication component for communicating information and a processor 704 coupled to the bus 702 for processing information. The computing system 700 can also include one or more processors 704 coupled to the bus 702 for processing information. The computing system 700 also includes memory 706, such as a RAM or other dynamic storage device, coupled to the bus 702 for storing information, and instructions to be executed by the processor 702. The memory 705 can also be used for storing position information, temporary variables, or other intermediate information during execution of instructions by the processor 702. The computing system 700 may further include a storage device 708 or other static storage device coupled to the bus 702 for storing static information and instructions for the processor 704. In some implementations, the storage device 708 may be a solid state device, magnetic disk or optical disk, which is coupled to the bus 702 for persistently storing information and instructions. The computing device 700 may include, but is not limited to, digital computers, such as laptops, desktops, workstations, personal digital assistants, servers, blade servers, mainframes, cellular telephones, smart phones, mobile computing devices (e.g., a notepad, e-reader, etc.) etc.

The computing system 700 may be coupled via the bus 702 to a display 710, such as a Liquid Crystal Display (LCD), Thin-Film-Transistor LCD (TFT), an Organic Light Emitting Diode (OLED) display, LED display, Electronic Paper display, Plasma Display Panel (PDP), and/or other display, etc., for displaying information to a user. An input device 712, such as a keyboard including alphanumeric and other keys, may be coupled to the bus 702 for communicating information and command selections to the processor 704. In another implementation, the input device 712 may be integrated with the display 710, such as in a touch screen display. The input device 712 can include a cursor control, such as a mouse, a trackball, or cursor direction keys, for communicating direction information and command selections to the processor 704 and for controlling cursor movement on the display 710.

According to various implementations, the processes and/or methods described herein can be implemented by the computing system 700 in response to the processor 704 executing an arrangement of instructions contained in memory 706. Such instructions can be read into the memory 706 from another computer-readable medium, such as the storage device 708. Execution of the arrangement of instructions contained in the memory 706 causes the computing system 700 to perform the illustrative processes and/or method steps described herein. One or more processors 704 in a multi-processing arrangement may also be employed to execute the instructions contained in the memory 706. In alternative implementations, hard-wired circuitry may be used in place of or in combination with software instructions to effect illustrative implementations. Thus, implementations are not limited to any specific combination of hardware circuitry and software.

The computing system 700 also includes a communications unit 714 that may be coupled to the bus 702 for providing a communication link between the system 700 and a network. As such, the communications unit 714 enables the processor 704 to communicate, wired or wirelessly, with other electronic systems coupled to the network. For instance, the communications unit 714 may be coupled to an Ethernet line that connects the system 700 to the Internet or another network. In other implementations, the communications unit 714 may be coupled to an antenna (not shown) and provides functionality to transmit and receive information over a wireless communication interface with the network.

In various implementations, the communications unit 714 may include one or more transceivers configured to perform data communications in accordance with one or more communications protocols such as, but not limited to, WLAN protocols (e.g., IEEE 802.11 a/b/g/n/ac/ad, IEEE 802.16, IEEE 802.20, etc.), PAN protocols, Low-Rate Wireless PAN protocols (e.g., ZigBee, IEEE 802.15.4-2003), Infrared protocols, Bluetooth protocols, EMI protocols including passive or active RFID protocols, and/or the like.

The communications unit 714 may include one or more transceivers configured to communicate using different types of protocols, communication ranges, operating power requirements, RF sub-bands, information types (e.g., voice or data), use scenarios, applications, and/or the like. In various implementations, the communications unit 714 may comprise one or more transceivers configured to support communication with local devices using any number or combination of communication standards.

In various implementations, the communications unit 714 can also exchange voice and data signals with devices using any number or combination of communication standards (e.g., GSM, CDMA, TDNM, WCDMA, OFDM, GPRS, EV-DO, WiFi, WiMAX, S02.xx, UWB, LTE, satellite, etc). The techniques described herein can be used for various wireless communication networks such as Code Division Multiple Access (CDMA) networks, Time Division Multiple Access (TDMA) networks, Frequency Division Multiple Access (FDMA) networks, Orthogonal FDMA (OFDMA) networks, Single-Carrier FDMA (SC-FDMA) networks, etc. A CDMA network can implement a radio technology such as Universal Terrestrial Radio Access (UTRA), cdma2000, etc. UTRA includes Wideband-CDMA (W-CDMA) and Low Chip Rate (LCR). CDMA2000 covers IS-2000, IS-95, and IS-856 standards. A TDMA network can implement a radio technology such as Global System for Mobile Communications (GSM). An OFDMA network can implement a radio technology such as Evolved UTRA (E-UTRA), IEEE 802.11, IEEE 802.16, IEEE 802.20, Flash-OFDM, etc. UTRA, E-UTRA, and GSM are part of Universal Mobile Telecommunication System (UMTS). Long Term Evolution (LTE) is an upcoming release of UMTS that uses E-UTRA. UTRA, E-UTRA, GSM, UMTS, and LTE are described in documents from an organization named “3rd Generation Partnership Project” (3GPP). CDMA2000 is described in documents from an organization named “3rd Generation Partnership Project 2” (3GPP2).

While this specification contains many specific implementation details, these should not be construed as limitations on the scope of what may be claimed, but rather as descriptions of features specific to particular implementations. Certain features described in this specification in the context of separate implementations can also be implemented in combination in a single implementation. Conversely, various features described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

As noted above, implementations within the scope of this disclosure include program products comprising non-transitory machine-readable media for carrying or having machine-executable instructions or data structures stored thereon. Such machine-readable media can be any available media that can be accessed by a general purpose or special purpose computer or other machine with a processor. By way of example, such machine-readable or non-transitory storage media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions comprise, for example, instructions and data which cause a general purpose computer, special purpose computer, or special purpose processing machines to perform a certain function or group of functions.

Implementations have been described in the general context of method steps which may be implemented in one implementation by a program product including machine-executable instructions, such as program code, for example in the form of program modules executed by machines in networked environments. Generally, program modules include routines, programs, objects, components, data structures, etc. that perform particular tasks or implement particular abstract data types. Machine-executable instructions, associated data structures, and program modules represent examples of program code for executing steps of the methods disclosed herein. The particular sequence of executable instructions or associated data structures represents examples of corresponding acts for implementing the functions described in such steps.

As previously indicated, implementations may be practiced in a networked environment using logical connections to one or more remote computers having processors. Those skilled in the art will appreciate that such network computing environments may encompass many types of computers, including personal computers, hand-held devices, multi-processor systems, microprocessor-based or programmable consumer electronics, network PCs, minicomputers, mainframe computers, and so on. Implementations may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative implementations. Accordingly, all such modifications are intended to be included within the scope of the present disclosure as defined in the appended claims. Such variations will depend on the software and hardware systems chosen and on designer choice. It is understood that all such variations are within the scope of the disclosure. Likewise, software and web implementations of the present disclosure could be accomplished with standard programming techniques with rule based logic and other logic to accomplish the various database searching steps, correlation steps, comparison steps and decision steps.

It is important to note that the construction and arrangement of the system shown in the various exemplary implementations is illustrative only and not restrictive in character. All changes and modifications that come within the spirit and/or scope of the described implementations are desired to be protected. It should be understood that some features may not be necessary and implementations lacking the various features may be contemplated as within the scope of the application, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

The foregoing description of implementations has been presented for purposes of illustration and description. It is not intended to be exhaustive or to limit the disclosure to the precise form disclosed, and modifications and variations are possible in light of the above teachings or may be acquired from this disclosure. The implementations were chosen and described in order to explain the principals of the disclosure and its practical application to enable one skilled in the art to utilize the various implementations and with various modifications as are suited to the particular use contemplated. Other substitutions, modifications, changes and omissions may be made in the design, operating conditions and arrangement of the implementations without departing from the scope of the present disclosure as expressed in the appended claims.

What is claimed is:

1. A method for determining regions indicative of conditions for supercooled droplets comprising:
receiving, by one or more processors, temperature profile data and air vapor density profile data;
calculating, using one or more processors, vapor pressure data based on the received temperature profile data and air vapor density profile data;
calculating, using one or more processors, equilibrium vapor pressure over water data based on the received temperature profile data;
determining, using one or more processors, one or more regions indicative of conditions for supercooled droplets based on the calculated vapor pressure data and the calculated equilibrium vapor pressure over water data; and
outputting data indicative of the determined one or more regions indicative of conditions for supercooled droplets.

2. The method of claim 1, wherein the outputted data comprises a visual diagram of the determined one or more regions indicative of conditions for supercooled water particles.

3. The method of claim 1, wherein the outputted data comprises a notification.

4. The method of claim 1, wherein the outputted data comprises an upper position and lower position of the determined one or more regions indicative of conditions for supercooled water particles.

5. The method of claim 1, wherein the outputted data is output to an aircraft.

6. The method of claim 1, wherein the received temperature profile data and air vapor density profile data is measured temperature profile data and air vapor density profile data.

7. The method of claim 6, wherein the measured temperature profile data and air vapor density profile data is received from a radiometer.

8. The method of claim 1, wherein the received temperature profile data and air vapor density profile data is forecasted temperature profile data and air vapor density profile data.

9. The method of claim 1 further comprising:
calculating, using one or more processors, equilibrium vapor pressure over ice data based on the received temperature profile data;
determining, using one or more processors, one or more regions indicative of conditions for evaporation deposition based on the calculated vapor pressure data, the calculated equilibrium vapor pressure over water data, and the calculated equilibrium vapor pressure over ice data; and
determining, using one or more processors, one or more regions indicative of conditions for droplet-ice depletion based on the calculated vapor pressure data and the calculated equilibrium vapor pressure over ice data.

10. The method of claim 1, wherein the received temperature profile data and air vapor density profile data comprises a vertical temperature profile vector and a vertical air vapor density profile vector, the vertical temperature profile vector comprising a plurality of temperatures, each of the plurality of temperatures corresponding to a vertical location, the vertical air vapor density profile vector comprising a plurality of air vapor densities, each of the plurality of air vapor densities corresponding to a vertical location.

11. The method of claim 10, wherein determining the one or more regions indicative of conditions for supercooled droplets is based on comparing the calculated vapor pressure data and the calculated equilibrium vapor pressure over water data for each vertical location.

12. A system comprising:
a radiometer;
one or more processors; and
one or more storage devices storing instructions that, when executed by the one or more processors, cause the one or more processors to perform operations comprising:
receiving temperature profile data and air vapor density profile data from the radiometer,
determining one or more regions indicative of conditions for supercooled droplets based on the received temperature profile data and air vapor density profile data from the radiometer, and
outputting data indicative of the determined one or more regions indicative of conditions for supercooled droplets.

13. The system of claim 12, wherein the outputted data comprises a visual diagram of the determined one or more regions indicative of conditions for supercooled water particles.

14. The system of claim 12, wherein the one or more storage devices stores instructions that, when executed by the one or more processors, cause the one or more processors to perform operations further comprising:
calculating vapor pressure data based on the received temperature profile data and air vapor density profile data, and
calculating equilibrium vapor pressure over water data based on the received temperature profile data,
wherein determining one or more regions indicative of conditions for supercooled droplets is based on comparing the calculated vapor pressure data and the calculated equilibrium vapor pressure over water data.

15. The system of claim 12, wherein the wherein the outputted data comprises a notification outputted to an aircraft.

16. The system of claim 12, wherein the outputted data comprises an upper position and lower position of the determined one or more regions indicative of conditions for supercooled water particles.

17. A non-transitory computer readable storage device storing instructions that, when executed by one or more processors, cause the one or more processors to perform operations comprising:
receiving temperature profile data and air vapor density profile data;
determining one or more regions indicative of conditions for supercooled droplets based on the received temperature profile data and air vapor density profile data; and
outputting data indicative of the determined one or more regions indicative of conditions for supercooled droplets.

18. The non-transitory computer readable storage device of claim 17 storing instructions that, when executed by one or more processors, cause the one or more processors to perform operations further comprising:
calculating vapor pressure data based on the received temperature profile data and air vapor density profile data; and
calculating equilibrium vapor pressure over water data based on the received temperature profile data;
wherein determining one or more regions indicative of conditions for supercooled droplets is based on comparing the calculated vapor pressure data and the calculated equilibrium vapor pressure over water data.

19. The non-transitory computer readable storage device of claim 17 storing instructions that, when executed by one or more processors, cause the one or more processors to perform operations further comprising:
calculating equilibrium vapor pressure over ice data based on the received temperature profile data;
determining one or more regions indicative of conditions for evaporation deposition based on the calculated vapor pressure data, the calculated equilibrium vapor pressure over water data, and the calculated equilibrium vapor pressure over ice data; and
determining one or more regions indicative of conditions for droplet-ice depletion based on the calculated vapor pressure data and the calculated equilibrium vapor pressure over ice data.

20. The non-transitory computer readable storage device of claim 17, wherein the outputted data comprises one of a visual diagram of the determined one or more regions indicative of conditions for supercooled water particles, a notification, or an alert.
